(19) United States
(12) Patent Application Publication
(10) Pub. No.: US 2001/0007593 A1
(43) Pub. Date: Jul. 12, 2001

(54) Method and unit for displaying images

(76) Inventor: Akira Oosawa, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/748,384

(22) Filed: Dec. 27, 2000

(30) Foreign Application Priority Data
Dec. 27, 1999 (JP) 370202/1999

(51) Int. Cl. G06K 9/00; G06K 9/32

(52) U.S. Cl. 382/132; 382/130; 382/294

(57) ABSTRACT

A time-temporally subtraction-image generating section performs subtraction between corresponding pixels of original images which are objects of comparison and reading. A registration section matches the anatomically characteristic parts of two or more subtraction images obtained through the subtraction process. A display-format setting section arranges and displays the registrated subtraction images on an image display surface.

### BACKGROUND OF THE INVENTION

1. Field of the Invention

The present invention relates generally to a method and unit for displaying images, and more particularly to an improvement in a method of displaying a plurality of interimage-processed images taken of the same subject.

2. Description of the Related Art

It has hitherto been performed in a wide variety of fields that a plurality of images taken of the same subject are compared and read and, based on the interval change between the images, a check of the subject is made.

For example, in the manufacturing field of industrial products, an image of a certain product photographed when it is brand-new, and an image of the product photographed after a durability test has been conducted on said the product, are compared and read, and attention is thereby directed to that part of the product for which a great interval change is shown between the two images, whereby a part to be enhanced to improve product durability is examined. In the medical field, a plurality of radiation images obtained by photographing a diseased part in a certain patient in a time series manner are compared and read by a doctor, whereby the course of the disease is grasped and the process of determining the proper treatment method the disease is made more efficient.

Thus, the comparison and reading of a plurality of images taken of the same subject have been widely performed in various fields, and there are cases in which these images are displayed on an image display unit, etc. to facilitate the comparison and reading. That is, the images are transformed to density or luminance signals and displayed on an image display unit, etc.

For cases in which a plurality of images become objects of comparison and reading, it is a common practice to merely arrange and display these images. However, a reader's greatest interest lies in the interval change between the images. For instance, in the case where a plurality of images are simply arranged and displayed, as described above, it becomes more difficult to find this interval change as it become smaller. Hence, there is a strong demand for an enhancement in comparison and reading efficiency.

### SUMMARY OF THE INVENTION

The present invention has been made in view of the aforementioned circumstances. Accordingly, it is the primary object of the invention to provide an image display method and an image display unit that are capable of displaying a plurality of images of the same subject which become objects of comparison and reading, so as to improve comparison and reading efficiency.

The image display method and unit of the present invention arranges, or switches in sequence, and display images subjected to interimage processing (interimage-processed images), such as two or more subtraction or registrated images, obtained from three or more images. In this manner, the image display method and unit of the present invention serve to render conspicuous and easy to recognize visually the interval change between images, thereby improving comparison and reading efficiency.

To achieve this end, there is provided an image display method comprising the steps of performing interimage processing on two original images, constituting each of two or more pairs of original images selected from three or more original images of the same subject, which become objects of comparison and reading; and arranging, or switching in sequence, and displaying two or more interimage-processed images generated by the interimage processing.

The subject used herein, in addition to the human body, etc., includes every possible object, such as animals and plants, industrial products, topography, a heavenly body, landscapes, etc.

For cases in which three or more images become objects of comparison and reading, with two of the three or more images constituting one pair of images, two or more pairs of images are set. The expression “two original images constituting each of two or more pairs of original images selected from three or more original images” means two of the three or more original images which together constitute a pair of images. By performing interimage processing on the images which constitute each pair of images, it is possible to obtain one or two images in which the interval change is conspicuous. For instance, for cases in which the “subtraction process”, i.e. the process of perfoeming subtraction between corresponding pixels between images is employed as the method of interimage processing, a single subtraction image is obtained from one pair of images. Wheres for cases in which the “registration process”, i.e. the process of registering display positions of structurally characteristic parts beween images of the same subject is employed as the method of interimage processing, two registrated images are obtained from one pair of images. Therefore, for cases in which interimage processing such as the subtraction process is carried out, in which only a single interimage-processed image is obtained from one pair of images, two or more interimage-processed images obtained from two or more pairs of images are arranged, or switched in sequence, and displayed. For cases in which interimage processing such the registration process is carried out, in which two interimage-processed images are obtained from one pair of images, two or more interimage-processed images obtained from one or more pairs of images are arranged, or switched in sequence, and displayed.

Inter-processed images to be arranged and displayed can be caused to be aligned and arranged in accordance with the display positions of structurally characteristic parts common to two or more images to be displayed. Thus, comparison and reading are made easier because movement of the eye becomes either horizontal or vertical, and reading efficiency is thereby improved. The expression “in accordance with aligned and arranged of structurally characteristic parts” means that images are arranged and displayed either at different positions along a lateral orientation with the vertical positions of the images aligned, or at different positions along a vertical orientation with the lateral positions of the images aligned.

On the other hand, interimage-processed images to be switched in sequence and displayed can be caused to be displayed so that the display positions of structurally characteristic parts common to two or more of the images to be displayed are registrated. In this case, comparison and reading are made easier because, each time images are switched, the eye is prevented from following the structurally characteristic parts and being thereby diminished in efficiency to focus. As a result, reading performance can be further improved. The expression “the display positions are registrated” means that images are displayed with both the lateral and vertical positions thereof registrated.

The “expression structurally characteristic part” is not used exclusively in referring to characteristic parts of external structures but in referring to characteristic parts (e.g., upper and lower edge parts, right and left edge parts, a center part, etc.) of anatomical structures (e.g., a lung field, a breastbone, maxillae, etc.)as well. From the standpoint of comparison and reading, it is particularly preferable to orient the images so as to enable easy viewing of the part of greatest interest. In addition, it is also useful to specify a reference part so as to enable the location of the part of interest to be easily ascertained.

Medical radiation images and images acquired in sequence in a time series manner are fitting examples of cases in which a plurality of images of the same subject which become objects of comparison and reading. The capability provided whereby a change with the passage of time can be read is advantageous.

From the standpoint of reading an interval change between images, the application of aforementioned interimage processing methods, the subtraction process, the registration process, or a combination of the registration process and the subtraction process applied thereafter is advantageous. The subtraction process of the present invention can be employed to produce: (1) an energy subtraction image (simple subtraction or weighted subtraction) that is obtained based on two original images, a high-energy exposure image and a low-energy exposure image, obtained by photographing a subject approximately at the same time in a time series manner, which differ in energy distribution from each other; (2) a time-temporally subtraction image that is obtained based on to original images taken at different points in time; (3) a digital subtraction angiography (DSA) image that is obtained based on two original images of a vein obtained by photographing the vein before and after injection of a contrast medium; and the like.

It is advantageous to select one of the two original images so that each of the interimage-processed images is generated based on the selected image, whereby a change in the interval change between images can be observed with the selected image serving as a reference image. Particularly, for cases in which there is an interest in a change with the passage of time in a diseased part, as in medical radiation images, a change with the passage of time in the diseased part can be most satisfactorily observed. Furthermore, it is preferable that for cases in which three or more original images are acquired in sequence in a time series manner, the selected image be the newest or oldest image in the time series.

It is preferable to generate each of the interimage-processed images of original images taken in a time series manner based on two images adjacent in the time series. It thereby becomes possible to observe the rate of change of an interval change between images and to ascertain changes due to the effect of treatment of a diseased part, etc.

It is also desirable that in the aforementioned image display method of the present invention, images be arranged, or switched, and displayed.

The image display unit of the present invention is a unit for carrying out the aforementioned image display method of the present invention. The image display unit comprises image display means; interimage processing means for performing interimage processing on two original images, constituting each of two or more pairs of original images selected from three or more original images of the same subject, which become objects of comparison and reading; and a display-format setting means for causing the image display means to arrange, or switch in sequence, and display two or more interimage-processed images obtained through the interimage processing means.

The image display unit may further comprise registration means for aligning display positions of structurally characteristic parts of the subject of the two or more interimage-processed images. Also, the image display unit may further comprise registration means for registering display positions of structurally characteristic parts of the subject in the two or more interimage-processed images.

The interimage processing methods employed by the interimage processing means comprise; the process of performing subtraction between corresponding pixels in two images of the same subject; the process of registering display positions of structural elements between two images of the same subject; or the process of registering positions of structural elements of the two images first, and then the process of performing subtraction between corresponding pixels in the two images may be performed.

The display-format setting means provides the capability to have the two or more interimage-processed images arranged, or switched in sequence, and displayed in the order that the images on which the interimage-processed images are based were taken.

According to the image display method and unit of the present invention, interimage processing is performed on a plurality of images of the same subject which become objects of comparison and reading, and the interimage-processed images obtained thereof are arranged, or switched in sequence, and displayed. As a result, the interval change between the images becomes more conspicuous, in comparison to cases in which the original images are merely dispaying without having been subjected to interimage processing. In addition, the reader can easily recognize the interval change visually. Thus, the image display method and unit of the present invention are capable of improving comparison and reading efficiency.

### BRIEF DESCRIPTION OF THE DRAWINGS

The present invention will be described in further detail with reference to the accompanying drawings wherein:

FIG. 1 is a block diagram showing an embodiment of an image display unit of the present invention;

FIG. 2 is a diagram showing three original images displayed on the image display unit shown in FIG. 1;

FIG. 3 is a flowchart showing how an temporally subtraction process is performed between the original images;

FIG. 4 is a diagram used to explain global matching;

FIG. 5 is a diagram used for explaining local matching;

FIG. 6 is a diagram showing how a non-linear warping process is performed;

FIG. 7 is a diagram showing a first transposed image P1″, a third original image P3, and a subtraction image Su1 generated by subtracting the first transposed image from the third original image;

FIG. 8 is a diagram showing two subtraction images displayed on the image display unit;

FIG. 9 is a diagram showing how a set of subtraction images and a set of transposed images are switched and displayed;

FIG. 10 is a diagram showing a set of subtraction images and an original image on which the subtraction images are based;

FIG. 11A is a diagram showing how each subtraction image is generated from two original images; and

FIG. 11B is a diagram showing a subtraction-image generating method differing from the method shown in FIG. 11A.

### DESCRIPTION OF THE PREFERRED EMBODIMENTS

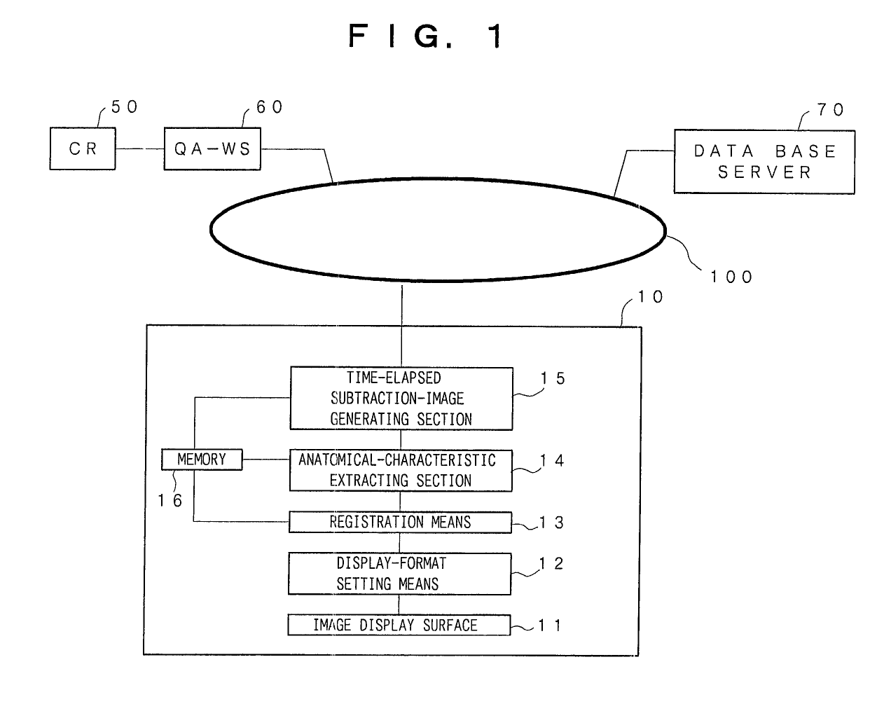

Referring initially to FIG. 1, there is shown a medical image network 100 that includes an image display unit 10 constructed according to a preferred embodiment of the present invention. This network 100 is connected to medical image generating equipment, such as computed tomographic (CT) equipment, magnetic resonance imaging (MRI) equipment, computed radiographic (CR) equipment 50, etc. The network 100 is also connected to a database server 70 for storing a great variety of diagnostic images generated by the CR equipment 50, etc., and an image display unit 10 for displaying an image stored temporarily in the database server 70, or an image sent directly from the CR equipment 50, etc. Furthermore, the network 100 is connected to a printer, etc. for outputting images being circulated in the network 100 to film, etc. Note that the printer, the CT equipment, the MRI equipment etc., are not shown in this diagram.

In the CR equipment 50, radiation transmitted through a subject is irradiated to a storage-type phosphor sheet having a stimulatable phosphor layer, whereby the transmitted radiation image of the subject is stored in the storage-type phosphor sheet. Then, laser light is irradiated to the storage-type phosphor sheet, and photostimulated luminescent light which has a light quantity corresponding to the radiation energy stored in the phosphor sheet, is photoelectrically detected. In this way, the radiation image transmitted through the subject is obtained as a digital image. The CR equipment 50 is widely used in medical institutions such as a hospital, etc.

Aquality workstation (QA-WS) 60 is interposed between the CR equipment 50 and the network 100 to check the quality of the diagnostic images generated by the image generating equipment such as the CR equipment 50, etc. The QA-WS 60 is equipped to perform functions such as requesting the image generating equipment to obtain an image again as occasion demands. The QA-WS 60 in this embodiment is provided for displaying a digital image P generated by the CR equipment 50 and checking picture quality (image density, contrast, etc.) photographing range, etc., before it is stored in the database server 70.

The image display unit 10 not only displays an image input through the network 100 as a visible image, but also has the function of performing a time-temporally subtraction process (hereinafter referred to as a subtraction process) on a plurality of images P obtained by photographing the same affected part of the same patient in a time series manner. The image display unit 10 is equipped with (1) a time-temporally subtraction-image generating section (an interimage processing means hereinafter referred to as a subtraction image generating section) 15 for generating a time-temporally subtraction image (hereinafter referred to as a subtraction image) Su obtained by the subtraction process, (2) an image display surface (image display means) 11 on which an image is displayed, (3) a memory 16 for temporarily storing an image, (4) an anatomical characteristic extracting means 14 for detecting an anatomically characteristic part (e.g., the upper edge of a lung field, etc.) which is an example of a structurally characteristic part in an image, (5) registration means 13 for registering the positions where anatomically characteristic parts in two or more subtraction images are displayed, and (6) a display-format setting means 12 for displaying these two or more images at the registrated display positions on the image display surface 11 by switching the images in sequence.

Now, the operation of the image display unit 10 in this embodiment will be described in detail.

The chest radiation transmission images P1, P2, and P3 of a specific patient are photographed at different times by the CR equipment 50. These images P1, P2, and P3 are checked for image quality, etc., by the QA-WS 60 and are stored in the database server 70 through the network 100. Also, an ID number specific to the photographed patient, a symbol indicating the photographed part (in this embodiment, the chest) and the photographing direction (e.g., a front direction), the date the patient was photographed, etc., have been attached as header information to each of the images P1, P2, and P3 being stored.

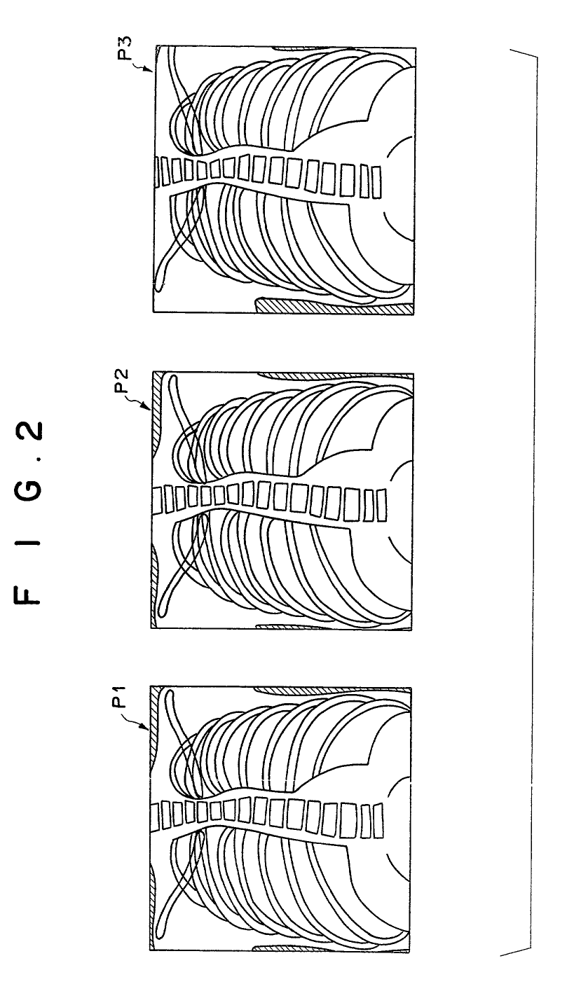

The three images P1, P2, and P3 with the header information (the same ID number, a symbol indicating the same photographed part, and a different photographing date) are input from the database server 70 through the network 100 and to the image display unit 10. These 3 images P1, P2, and P3, which differ from one another in photographing date are frontal images of the chest of the same patient, and are to be compared in a time series manner. Note that the second image P2 is newer in photographing-time than the first image P1, and the third image P3 is newer in photographing-time than the second image P2 (FIGS. 2A, 2B, and 2C).

The 3 time-series images P1, P2, and P3, input to the image display unit 10, are input to the subtraction-image generating section 15. The subtraction-image generating section 15 performs the subtraction process of calculating the interval change between corresponding pixels in the third and second images (P3 and P2, respectively), and the interval change between corresponding pixels in the third and first images (P3 and P2, respectively), using the third image P, which is the newest among the three images as the reference image. However, it is considered an impossibility that the location or form of a subject (e.g., the chest of a patient) will be exactly the same between two images differing in photographing time. Therefore, there is a high possibility that if the subtraction process is performed between corresponding pixels in the two original images differing in photographing time, the subtraction process will be carried out between different tissues, i.e. subtraction is performed between a bone part and a soft part.

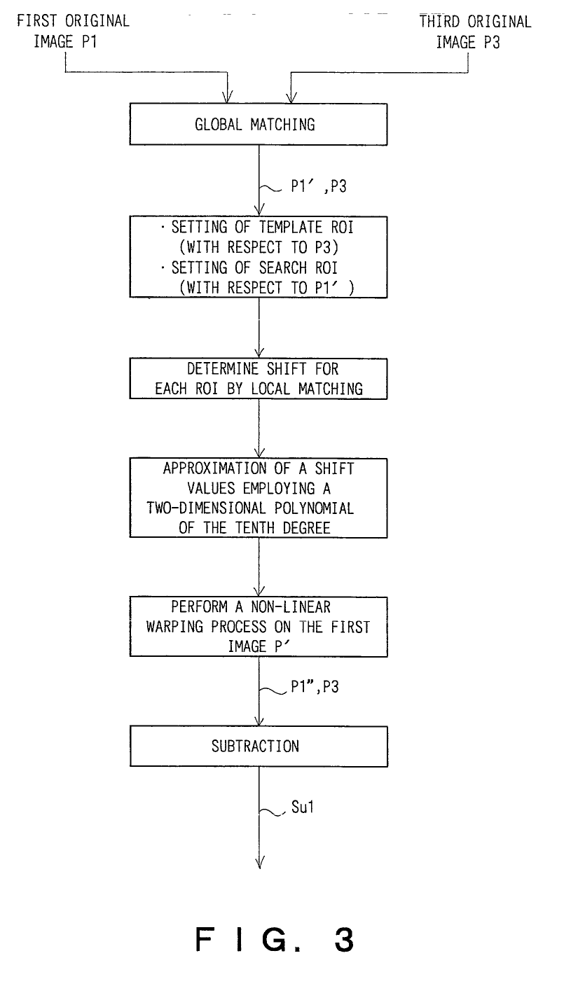

Therefore, the subtraction-image generating section 15 first performs the registration process and then performs the subtraction process, as in the first image P1 and the third image P3 shown in FIG. 3. The contents of the process of the subtraction-image generating section 15 will hereinafter be described with reference to the first image P1 and the second image P3 as examples.

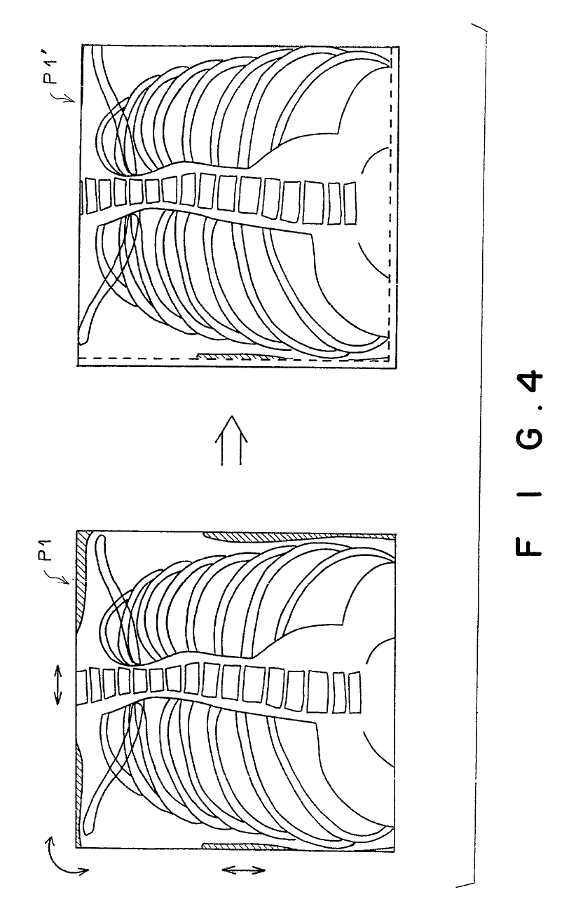

A global registration process is first performed between the first original image P1 and the third original image P3. This is the process of performing affine transposition (rotation and parallel shift) on the first original image Pi so that the first original image P1 is registrated with the third original image P3. This process converts the first original image Pi into a first image P1′, as shown in FIG. 4.

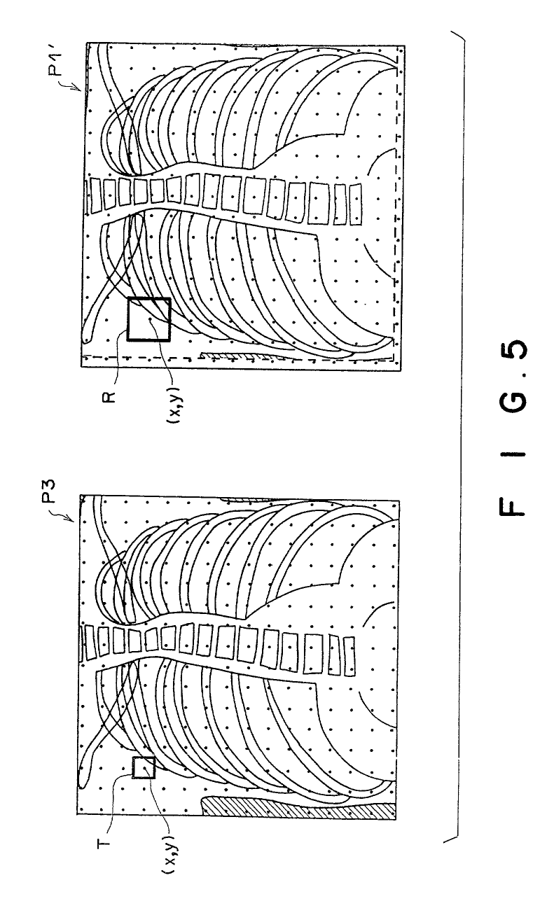

Next, the subtraction-image generating section 15 segments the entire third original image P3 into a plurality of regions of interest (ROIs)T and represents the center pixel of each ROI (T) in terms of an x-y coordinate system (x, y) (refer to FIG. 5). The subtraction-image generating section 15 also sets search ROIs (R) to the first image P1′. These search ROIs (R) are set in correlation with the ROIs (T) of the third original image P3, respectively. Each search ROI (R) has the same center coordinates (x, y) and is doubled in longitudinal and lateral lengths, and therefore has an area 4 times the ROI (T).

Into each search ROI (R) set to the first image P1′, the subtraction-image generating section 15 moves the corresponding ROI (T) of the third original image P3, and seeks out the position (center position (x′, y′) of ROI) where the degree of matching between the images P3 and P1′ becomes highest for each ROI (R) (calculation of shift values for each ROI by local matching). Note that an index value based on cross-correlation, for example, can be employed as an index value indicating whether the degree of matching is high or low.

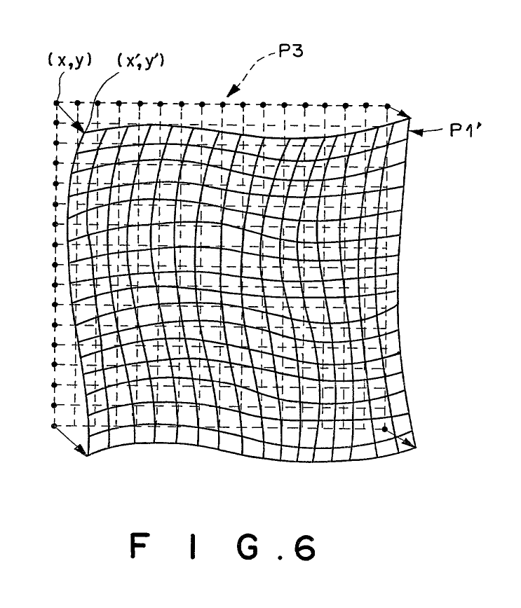

The shift value (Δx, Δy where Δx=x′−x and Δy=y′−y) obtained in this manner for the center pixel (x, y) of each corresponding ROI between the images P3 and P1′ is as shown in FIG. 6. Also, to derive the shift values (Δx, Δy) for all pixels in the first image P1′ by using the shift value (Δx, Δy) for each center pixel (x, y), an approximation process is performed using a two-dimensional polynomial of the tenth degree, and based on the shift value (Δx, Δy) obtained thereof for each pixel, the first image P1′ is subjected to the-non-linear warping process of shifting each pixel (x, y) of the first image P1′.

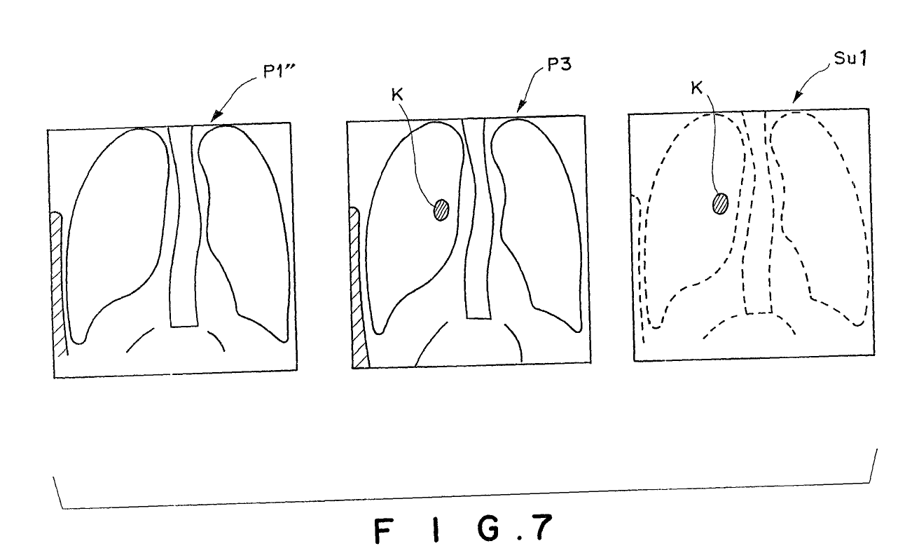

The first transposed image P1″, obtained by warping the first image P1′, results in an image in which the registration of tissues present in the corresponding pixels of the third original image P3 is extremely satisfactory (see FIG. 7). As shown in the same figure, a first subtraction image Sᵤ₁, in which the interference of artifacts due to a boundary line between tissues is extremely slight, is generated by subtracting a pixel in the third original image P3 from a corresponding pixel in the first transformed image P1″. The first subtraction image Su1 is embossed with a diseased part K, which is not present in the first original image P1, but is present in the left lung field of the third original image P3.

The subtraction-image generating section 15 generates a second subtraction image Su2 by performing the registration process and the subtraction process between the third image P3 and the second image P2 in a similar method as the aforementioned method, using the third image P3 as the reference image.

The two subtraction images Su1 and Su2 generated by the subtraction-image generating section 15 are input to the anatomical-characteristic extracting means 14. The anatomical-characteristic extracting means 14 detects anatomically characteristic parts (e.g., the position of the upper edge of a lung field) common to the input two subtraction images Su1 and Su2 and inputs the positions of the detected anatomically characteristic parts to the registration means 13.

The registration means 13 calculates the registering positions for the two subtraction images Su1 and Su2 so that the height positions of the anatomically characteristic parts detected are aligned with each other and are arranged and displayed along a lateral orientation. In this embodiment, the subtraction images Su1 and Su2 are both registrated using the third original image P3 as reference, so both the subtraction images Su1 and Su2 have in effect been registrated in advance. Therefore, it is possible to calculate the aforementioned registering positions without the detection of anatomically characteristic parts for alignment. However, the two subtraction images Su1 and Su2 can be generated with different images as references for alignment. Therefore, for two or more subtraction images generated with different images as references for alignment, anatomically characteristic parts common to the images are extracted by the anatomical-characteristic extracting means 14, and the registering positions for the subtraction images are calculated by the registration means 13 so that the height positions of the common anatomical characteristic parts are registrated, arranged and displayed along a lateral orientation.

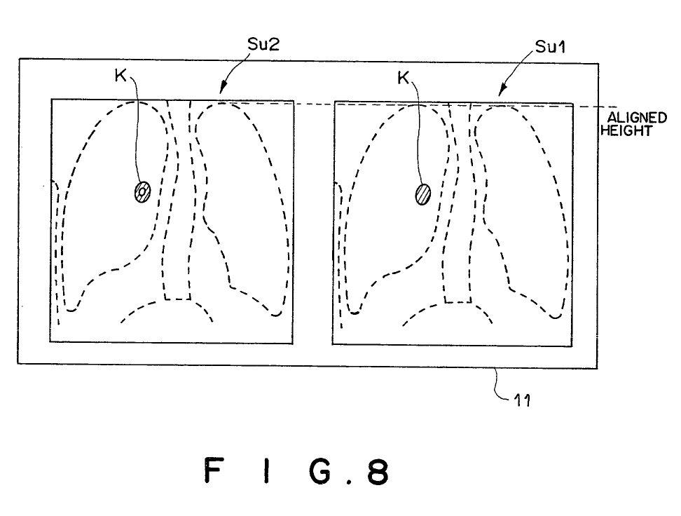

The two subtraction images Su1 and Su2 registrated in the aforementioned manner are input to the display-format setting means 12. For the two subtraction images Su1 and Su2 input to the display-format setting means 12, the display-format setting means 12 sets the display format in which the images are arranged and displayed at predetermined registering positions on the image display surface 11. The two subtraction images Su1 and Su2 are arranged and displayed at the predetermined positions (FIG. 8).

In the arranged and displayed subtraction images obtained in this manner through the registration process and the subtraction process, an interval change between the images is rendered more conspicuous, compared with the original image merely displayed without having been subjected to the registration process and the subtraction process (subtraction process in which subtraction is performed between corresponding pixels in two images). In addition, the reader can easily recognize the interval change visually. Thus, comparison and reading efficiency is improved considerably.

While the display-format setting means 12 in the image display unit 10 of this embodiment adopts the format in which two subtraction images are arranged and displayed along a lateral orientation, it is also possible to have three images (the third reference image P3 and two subtraction images Su1 and Su2) arranged and displayed. This is advantageous in that the reader can clearly recognize the interval change between the reference image and the subtraction images.

In the image display method and unit of the present invention, it is also possible to have two subtraction images arranged and displayed along a vertical orientation with the lateral positions of the two images aligned with each other. In addition, it is also possible to have the two subtraction images switched one by one and displayed in sequence, with the lateral and vertical positions of the two images aligned with each other.

In the image display unit 10 of this embodiment, two subtraction images are generated based on three original images, and the two subtraction images are arranged and displayed along a lateral orientation, or switched one by one and displayed. However, the image display method and unit of the present invention are not limited to the embodiment in which the subtraction process is employed as the interimage processing method. The registration process whereby display positions between a plurality of original images may also employed as the interimage processing method. In this case, the image display unit does not need to be equipped with the subtraction-image generating section 15. Instead, the image display unit may be equipped with such a registration section which carries out the steps up to the warping step among the steps shown in FIG. 3.

Furthermore, although the image display unit of this embodiment arranges and displays only two images subjected to the interimage processing, or switches and displays the images in sequence, the present invention is not to be limited to this. 3 or more images may be arranged and displayed, or switched and displayed in sequence, depending on the contents of the interimage processing and the number of images acquired.

The interimage-processed images may be arranged and displayed in the time order that the interimage-processed images are acquired, or in the time order that the original images to be used in the interimage processing were taken.

Application of the interimage processing methods such as the registration process, the subtraction process, etc., is not limited to the process of acquiring a plurality of interimage-processed images based on a common image as the reference image. For example, for cases in which a great number of original images acquired in sequence in a time series manner, the interimage processing method performed between images adjacent in the time series may consist of sequentially switching an original image which becomes the reference image, whereby a plurality of interimage-processed images may be acquired.

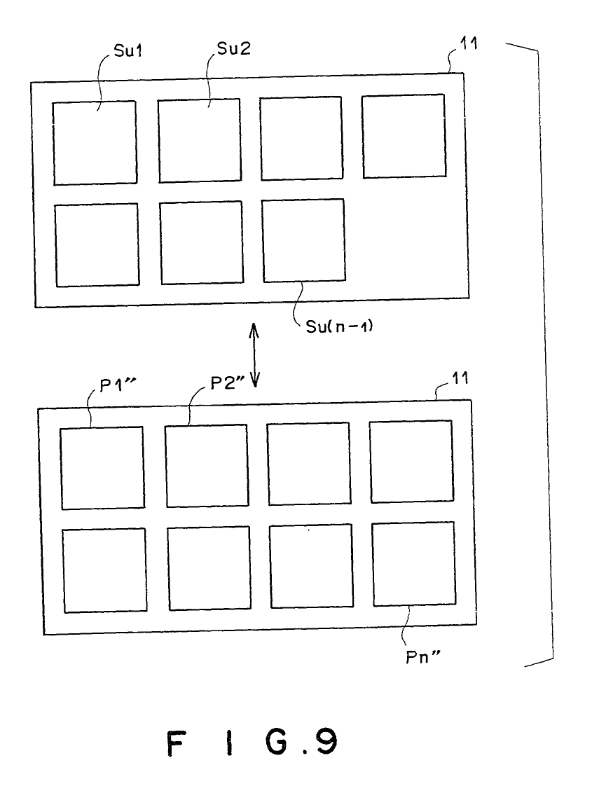

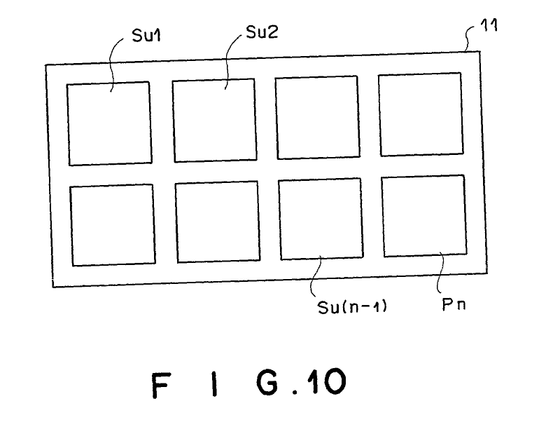

As shown in FIG. 9, a plurality of subtraction images Sui (where i=1, 2, . . . , and n−1), and a plurality of images Pi″ (where i=1,2, . . . ,and n) registrated by non-linear warping, may be switched and displayed on the image display surface 11. In this case, an image (e.g., Pn) which becomes a reference image for the subtraction process can be added to the subtraction images Sui (where i=1, 2, . . . , and n−1) as occasion demands (see FIG. 10).

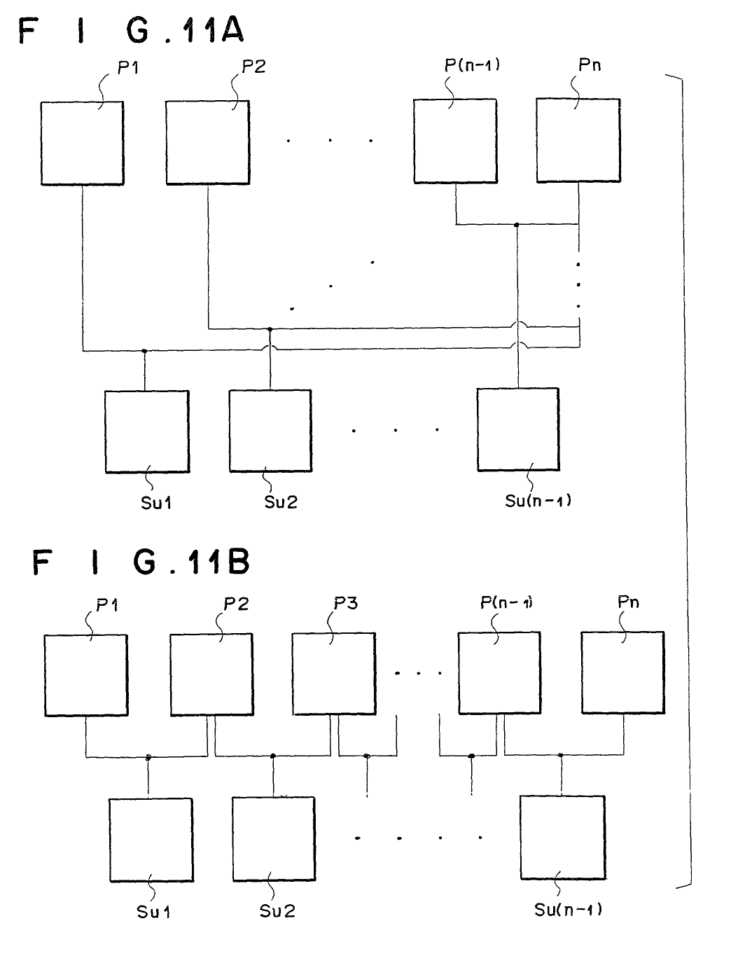

The subtraction images Sui (where i=1, 2, . . . , and n−1) thus displayed on the image display surface 11 may be generated using the latest original image Pn as the reference image at all times (see FIG. 11A), or may be generated between two original images Pi−1 and Pi adjacent in a time series (see FIG. 11B). For cases in which switching and displaying these subtraction images is performed, they may be displayed in the ascending chronological order (from youngest to oldest) of a time series from the subtraction image Su(n−1) obtained by the subtraction process employing the original image P(n−1) from the younger side in a time series (i.e., in the order of Su(n−1), Su(n−2), . . . , Su2, and Su1). Alternatively, they may be displayed in the descending chronological order (from oldest to youngest) that they become newer in a time series from the subtraction image Su1 obtained by the subtraction process employing the original image P1 from the older side in a time series (i.e. in the order of Su1, Su2, . . . , Su(n−2), and Su(n−1)).

While the image display unit of this embodiment displays subtraction images obtained primarily by the process disclosed in Japanese Unexamined Patent Publication No. 7(1995)-37074, application of the image display method and unit of the present invention is not limited to subtraction images. The present invention is capable of handling all kinds of images, whether a subject is a living organism or not, along as they are two or more images of the same subject which become objects of comparison and reading, such as (1) two original images (a high-energy exposure image and a low-energy exposure image), obtained by photographing the subject at the same time in a time series manner, which differ in energy distribution, and subtraction images obtained based on these, (2) two original images of a vein obtained by photographing the vein after and before injection of a contrast medium, and DSA images obtained based on these, and the like. In addition, all of the contents of Japanese Patent Application No. 11(1999)-370202 are incorporated into this specification by reference.

What is claimed is:

1. An image display method comprising the steps of:
performing interimage processing on two original images, constituting each of two or more pairs of original images selected from three or more original images taken of the same subject, which become objects of comparison and reading; and
arranging, or switching in sequence, and displaying two or more interimage-processed images generated by said interimage processing.

2. The image display method as set forth in claim 1, wherein said two or more interimage-processed images are arranged in a manner in which display positions of structurally characteristic parts of said subject in said two or more interimage-processed images are aligned.

3. The image display method as set forth in claim 1, wherein said two or more interimage-processed images are switched in sequence in a manner in which display positions of structurally characteristic parts of said subject in said two or more interimage-processed images are registrated.

4. The image display method as set forth in claim 1, wherein said three or more original images are taken in sequence in a time series manner.

5. The image display method as set forth in claim 2, wherein said three or more original images are taken in sequence in a time series manner.

6. The image display method as set forth in claim 3, wherein said three or more original images are taken in sequence in a time series manner.

7. The image display method as set forth in claim 1, wherein one of said two original images is selected as a reference image so that each of said interimage-processed images is generated based on said image.

8. The image display method as set forth in claim 2, wherein one of said two original images is selected as a reference image so that each of said interimage-processed images is generated based on said image.

9. The image display method as set forth in claim 3, wherein one of said two original images is selected as a reference image so that each of said interimage-processed images is generated based on said image.

10. The image display method as set forth in claim 4, wherein one of said two original images is selected as a reference image so that each of said interimage-processed images is generated based on said image.

11. The image display method as set forth in claim 7, wherein said three or more original images are acquired in sequence in a time series manner, and said reference image is the newest or oldest in a time series.

12. The image display method as set forth in claim 4, wherein each of said interimage-processed images is generated by performing said interimage processing on two of said three or more original images which are adjacent in a time series.

13. The image display method as set forth in claim 1, wherein said interimage processing is the process of performing subtraction between corresponding pixels in said two original images.

14. The image display method as set forth in claim 2, wherein said interimage processing is the process of performing subtraction between corresponding pixels in said two original images.

15. The image display method as set forth in claim 3, wherein said interimage processing is the process of performing subtraction between corresponding pixels in said two original images.

16. The image display method as set forth in claim 1, wherein said interimage processing is the process of registering positions of structural elements of said two original images.

17. The image display method as set forth in claim 2, wherein said interimage processing is the process of registering positions of structural elements of said two original images.

18. The image display method as set forth in claim 3, wherein said interimage processing is the process of registering positions of structural elements of said two original images.

19. The image display method as set forth in claim 1, wherein, in said interimage processing the process of registering positions of structural elements of said two original images is first performed, and then the process of performing subtraction between corresponding pixels in said two original images is performed.

20. The image display method as set forth in claim 2, wherein, in said interimage processing the process of registering positions of structural elements of said two original images is first performed, and then the process of performing subtraction between corresponding pixels in said two original images is performed.

21. The image display method as set forth in claim 3, wherein, in said interimage processing the process of registering positions of structural elements of said two original images is first performed, and then the process of performing subtraction between corresponding pixels in said two original images is performed.

22. The image display method as set forth in claim 1, wherein said two or more interimage-processed images are arranged, or switched in sequence, and displayed, in the order that said original images on which said interimage-processed images are based were taken.

23. The image display method as set forth in claim 1, wherein said three or more images are medical radiation images.

24. The image display method as set forth in claim 2, wherein each of said interimage-processed images is generated by performing said interimage processing on two of said three or more original images which are adjacent in a time series.

25. The image display method as set forth in claim 3, wherein each of said interimage-processed images is generated by performing said interimage processing on two of said three or more original images which are adjacent in a time series.

26. An image display unit comprising:
image display means;
interimage processing means for performing interimage processing on two original images, constituting each of two or more pairs of original images selected from three or more original images of the same subject, which become objects of comparison and reading; and
display-format setting means for causing said image display means to arrange, or switch in sequence, and display two or more interimage-processed images obtained by said interimage processing means.

27. The image display unit as set forth in claim 26, further comprising registration means for aligning display positions of structurally characteristic parts of said subject in said two or more interimage-processed images.

28. The image display unit as set forth in claim 26, further comprising registration means for registering display positions of structurally characteristic parts of said subject in said two or more interimage-processed images.

29. The image display unit as set forth in claim 26, wherein said three or more original images were taken in sequence in a time series manner.

30. The image display unit as set forth in claim 27, wherein said three or more original images were taken in sequence in a time series manner.

31. The image display unit as set forth in claim 28, wherein said three or more original images were taken in sequence in a time series manner.

32. The image display unit as set forth in claim 26, wherein one of said two original images is selected as a reference image so that each of said interimage-processed images is generated based on said reference image.

33. The image display unit as set forth in claim 27, wherein one of said two original images is selected as a reference image so that each of said interimage-processed images is generated based on said reference image.

34. The image display unit as set forth in claim 28, wherein one of said two original images is selected as a reference image so that each of said interimage-processed images is generated based on said reference image.

35. The image display unit as set forth in claim 29, wherein one of said two original images is selected as a reference image so that each of said interimage-processed images is generated based on said reference image.

36. The image display unit as set forth in claim 32, wherein said three or more original images were taken in sequence in a time series manner, and said selected one original image is the newest or oldest in a time series.

37. The image display unit as set forth in claim 26, wherein each of said interimage-processed images is generated by performing said interimage processing on two of said three or more original images which are adjacent in a time series.

38. The image display unit as set forth in claim 26, wherein said interimage processing in said interimage processing means is the process of performing subtraction between corresponding pixels in said two original images.

39. The image display unit as set forth in claim 27, wherein said interimage processing in said interimage processing means is the process of performing subtraction between corresponding pixels in said two original images.

40. The image display unit as set forth in claim 28, wherein said interimage processing in said interimage processing means is the process of performing subtraction between corresponding pixels in said two original images.

41. The image display unit as set forth in claim 26, wherein said interimage processing in said interimage processing means is the process of registering positions of structural elements of said two original images.

42. The image display unit as set forth in claim 27, wherein said interimage processing in said interimage processing means is the process of registering positions of structural elements of said two original images.

43. The image display unit as set forth in claim 28, wherein said interimage processing in said interimage processing means is the process of registering positions of structural elements of said two original images.

44. The image display unit as set forth in claim 26, wherein, in said interimage processing in said interimage processing means, the process of registering positions of structural elements of said two original images is first performed, and then the process of performing subtraction between corresponding pixels in said two original images is performed.

45. The image display unit as set forth in claim 27, wherein, in said interimage processing in said interimage processing means, the process of registering positions of structural elements of said two original images is first performed, and then the process of performing subtraction between corresponding pixels in said two original images is performed.

46. The image display unit as set forth in claim 28, wherein, in said interimage processing in said interimage processing means, the process of registering positions of structural elements of said two original images is first performed, and then the process of performing subtraction between corresponding pixels in said two original images is performed.

47. The image display unit as set forth in claim 26, wherein said display-format setting means arranges, or switches in sequence, and displays said two or more interimage-processed images in the order that said original images on which said interimage-processed images are based were taken.

48. The image display unit as set forth in claim 26, wherein said three or more images are medical radiation images.
